(19) United States
(12) Patent Application Publication
(10) Pub. No.: US 2013/0227928 A1
(43) Pub. Date: Sep. 5, 2013

(54) FUEL NOZZLE ASSEMBLY FOR USE IN TURBINE ENGINES AND METHOD OF ASSEMBLING SAME

(71) Applicants: Jong Ho Uhm, Simpsonville, SC (US); Thomas Edward Johnson, Greer, SC (US)

(72) Inventors: Jong Ho Uhm, Simpsonville, SC (US); Thomas Edward Johnson, Greer, SC (US)

(21) Appl. No.: 13/410,168

(22) Filed: Mar. 1, 2012

(51) Int. Cl. F02C 7/18; B21D 53/84; F02C 3/20; F02C 7/22; F23R 3/54

(52) U.S. Cl. 60/39.58; 60/737; 60/758; 60/746; 29/889.22

(57) ABSTRACT

A fuel nozzle for use with a turbine engine is provided. The fuel nozzle includes a housing coupled to a combustor liner defining a combustion chamber. The housing is at least partially positioned within an air plenum and comprises an endwall that at least partially defines the air plenum. The fuel nozzle includes a plurality of mixing tubes extending through the housing for channeling a fuel to the combustion chamber, a cooling fluid plenum at least partially defined within the housing by the housing endwall, and a plurality of apertures defined within the housing endwall for channeling a cooling fluid from the cooling fluid plenum to the air plenum.

### STATEMENT REGARDING FEDERALLY SPONSORED RESEARCH & DEVELOPMENT

This invention was made with Government support under contract number DE-FC26-05NT42643 awarded by the Department of Energy. The Government has certain rights in this invention.

### BACKGROUND OF THE INVENTION

The subject matter disclosed herein generally relates to turbine engines and, more particularly, to a fuel nozzle assembly for use in a turbine engine.

At least some known turbine engines are used in cogeneration facilities and power plants. Such engines may have high specific work and power per unit mass flow requirements. To increase the operating efficiency, at least some known turbine engines, such as gas turbine engines, operate with increased combustion temperatures. In at least some known gas turbine engines, engine efficiency increases as combustion gas temperatures increase.

However, operating with higher temperatures may also increase the generation of polluting emissions, such as oxides of nitrogen (NOₓ). In an attempt to reduce the generation of such emissions, at least some known turbine engines include improved combustion system designs. For example, many combustion systems may use premixing technology that includes micro-mixers that facilitate mixing substances, such as diluents, gases, and/or air with fuel to generate a fuel mixture for combustion.

However, the benefits of such combustion systems may be limited. High H₂ concentrations created by such combustion systems may generate a high dynamics tone greater than 1 kHz that is audible as a screech. The high dynamics tone may increase the wear of the combustor and its associated components, and/or may shorten the useful life of the combustion system and, in extreme cases, may cause damage to the combustion system.

### BRIEF DESCRIPTION OF THE INVENTION

In one embodiment a fuel nozzle for use with a turbine engine is provided. The fuel nozzle includes a housing coupled to a combustor liner defining a combustion chamber. The housing is at least partially positioned within an air plenum and comprises an endwall that at least partially defines the air plenum. The fuel nozzle includes a plurality of mixing tubes extending through the housing for channeling a fuel to the combustion chamber, a cooling fluid plenum at least partially defined within the housing by the housing endwall, and a plurality of apertures defined within said housing endwall for channeling a cooling fluid from the cooling fluid plenum to the air plenum.

In another embodiment, a combustor assembly for use with a turbine engine is provided. The combustor assembly includes a casing comprising an air plenum, a combustor liner positioned within the casing and defining a combustion chamber therein, and a plurality of fuel nozzles coupled to the combustor liner. Each fuel nozzle of the plurality of fuel nozzles includes a housing coupled to the combustor liner. The housing comprises an endwall that at least partially defines the combustion chamber, a plurality of mixing tubes extending through the housing for channeling a fuel to the combustion chamber, a cooling fluid plenum at least partially defined within the housing by the housing endwall, and a plurality of apertures defined within said housing endwall for channeling a cooling fluid from the cooling fluid plenum to the air plenum.

In yet another embodiment, a method of assembling a fuel nozzle for use with a turbine engine is provided. The method includes coupling a housing to a combustor liner that defines a combustion chamber. The housing is at least partially positioned within an air plenum and comprises an endwall that at least partially defines the air plenum. The method includes coupling a plurality of mixing tubes to the housing for channeling a fuel to the combustion chamber, forming a cooling fluid plenum at least partially within the housing, and forming a plurality of apertures for channeling a cooling fluid from the cooling fluid plenum to the air plenum.

### BRIEF DESCRIPTION OF THE DRAWINGS

FIG. 1 is a schematic cross-sectional view of an exemplary turbine engine;

FIG. 2 is a sectional view of an exemplary fuel nozzle assembly that may be used with the turbine engine shown in FIG. 1 and taken along area 2;

FIG. 3 is a cross-sectional view of a portion of an exemplary fuel nozzle assembly taken along line 3-3 (shown in FIG. 2);

FIG. 4 is an enlarged cross-sectional view of a portion of an exemplary fuel nozzle taken along area 4 (shown in FIG. 2);

FIG. 5 is an enlarged schematic view of a portion of an exemplary fuel nozzle that may be used with the fuel nozzle assembly shown in FIG. 3 and taken along area 6 (shown in FIG. 4); and

FIG. 6 is an enlarged schematic view of a portion of an alternative fuel nozzle that may be used with the fuel nozzle assembly shown in FIG. 3 and taken along area 6 (shown in FIG. 4).

Like reference numbers and designations in the various drawings indicate like elements.

### DETAILED DESCRIPTION OF THE INVENTION

The exemplary apparatus, systems, and methods described herein overcome at least some known disadvantages associated with at least some known combustion systems of turbine engines that operate with higher temperatures. The embodiments described herein provide a fuel nozzle assembly that may be used with turbine engines to facilitate at least one of reducing a temperature of a component within the combustor, reducing NOₓ produced by operation of the combustor, mitigating combustion dynamics produced by operation of the combustor, and improving operability or durability of components of the combustor. More specifically, the fuel nozzle assembly includes a plurality of fuel nozzles that each include a plurality of tubes and has both an upstream surface and a downstream surface. The upstream surface of at least one of the fuel nozzles has at least one opening. Cooling fluid is channeled through the fuel nozzle from a cooling fluid supply to at least one opening to mix with air and other fluids on the cold side of the fuel nozzle. More specifically, by channeling the cooling fluid to at least one opening, the peak temperature of combustion is reduced, NOₓ is reduced, combustion dynamics are reduced, and operability and durability of the combustor are increased.

As used herein, the term “cooling fluid” refers to nitrogen, air, fuel, diluents, inert gases, or some combination thereof, and/or any other fluid that enables the fuel nozzle to function as described herein.

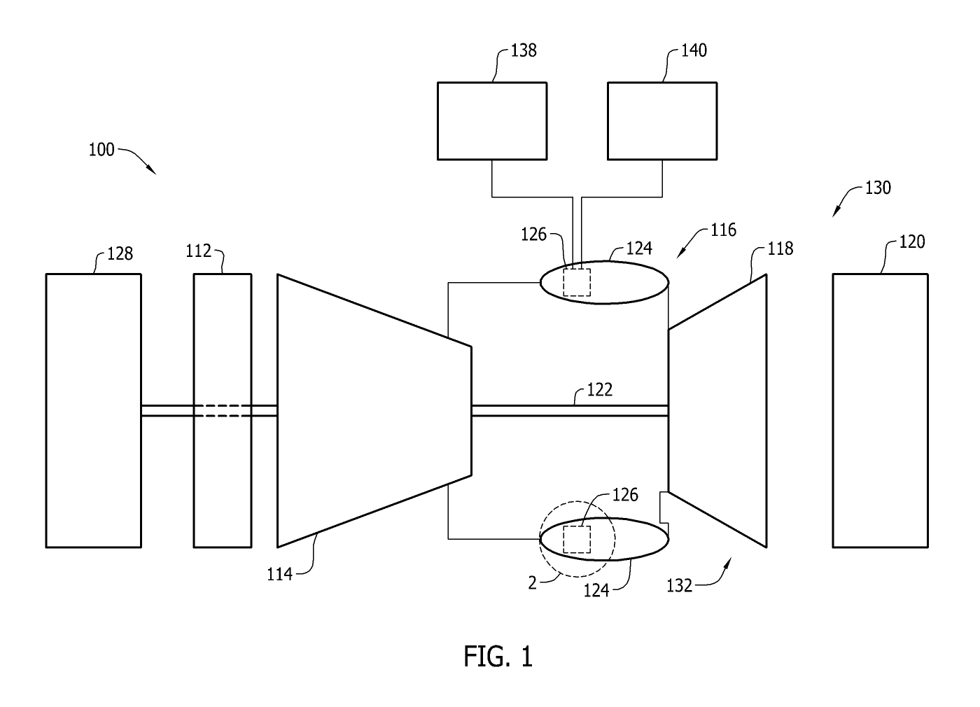

FIG. 1 is a schematic cross-sectional view of an exemplary turbine engine 100. More specifically, turbine engine 100 is a gas turbine engine. While the exemplary embodiment includes a gas turbine engine, the present invention is not limited to any one particular engine, and one of ordinary skill in the art will appreciate that the current invention may be used in connection with other turbine engines.

Moreover, in the exemplary embodiment, turbine engine 100 includes an intake section 112, a compressor section 114 coupled downstream from intake section 112, a combustor section 116 coupled downstream from compressor section 114, a turbine section 118 coupled downstream from combustor section 116, and an exhaust section 120. Turbine section 118 is coupled to compressor section 114 via a rotor shaft 122. In the exemplary embodiment, combustor section 116 includes a plurality of combustor assemblies 124. Combustor section 116 is coupled to compressor section 114 such that each combustor assembly 124 is positioned in flow communication with the compressor section 114. A fuel nozzle assembly 126 is coupled within each combustor assembly 124. Turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 that is coupled to a rotor shaft 122 to form a rotor assembly 132. A fuel supply system 138 is coupled to each fuel nozzle assembly 126 for channeling a flow of fuel to fuel nozzle assembly 126. In addition, a cooling fluid supply system 140 is coupled to each fuel nozzle assembly 126 for channeling a flow of cooling fluid to each fuel nozzle assembly 126.

During operation, intake section 112 channels air towards compressor section 114 wherein the air is compressed to a higher pressure and temperature prior to being discharged towards combustor section 116. The compressed air is mixed with fuel and other fluids that are provided by each fuel nozzle assembly 126 and ignited to generate combustion gases that are channeled towards turbine section 118. More specifically, each fuel nozzle assembly 126 injects fuel, such as natural gas and/or fuel oil, air, and/or diluents, such as nitrogen gas (N₂) in respective combustor assemblies 124, and into the air flow. The fuel and air mixture is ignited to generate high temperature combustion gases that are channeled toward turbine section 118. Turbine section 118 converts the thermal energy from the gas stream to mechanical rotational energy, as the combustion gases impart rotational energy to turbine section 118 and to rotor assembly 132. By having each fuel nozzle assembly 126 inject the fuel with air and/or diluents in respective combustor assemblies 124, the peak temperature, combustion dynamics and/or NOx may be reduced within each combustor assembly 124.

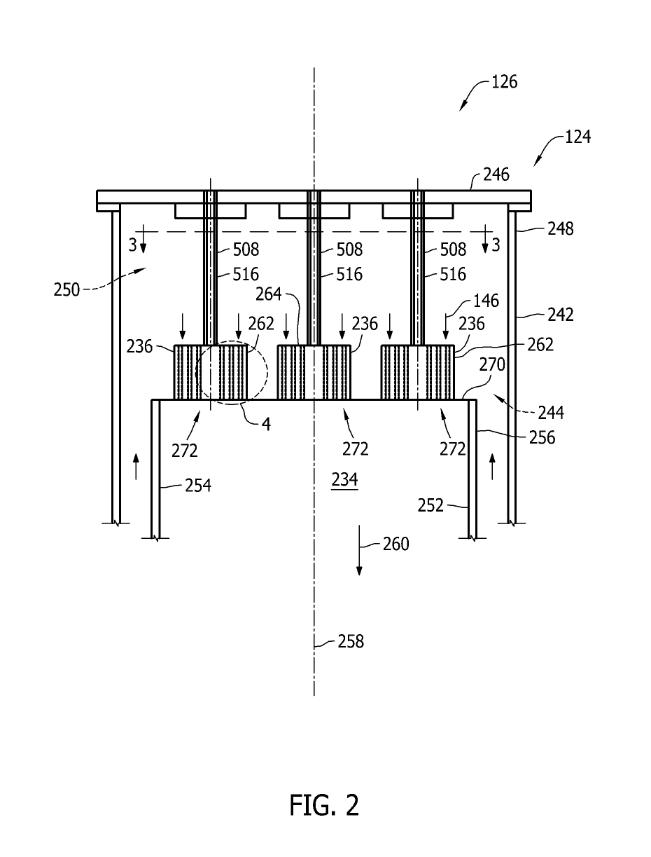

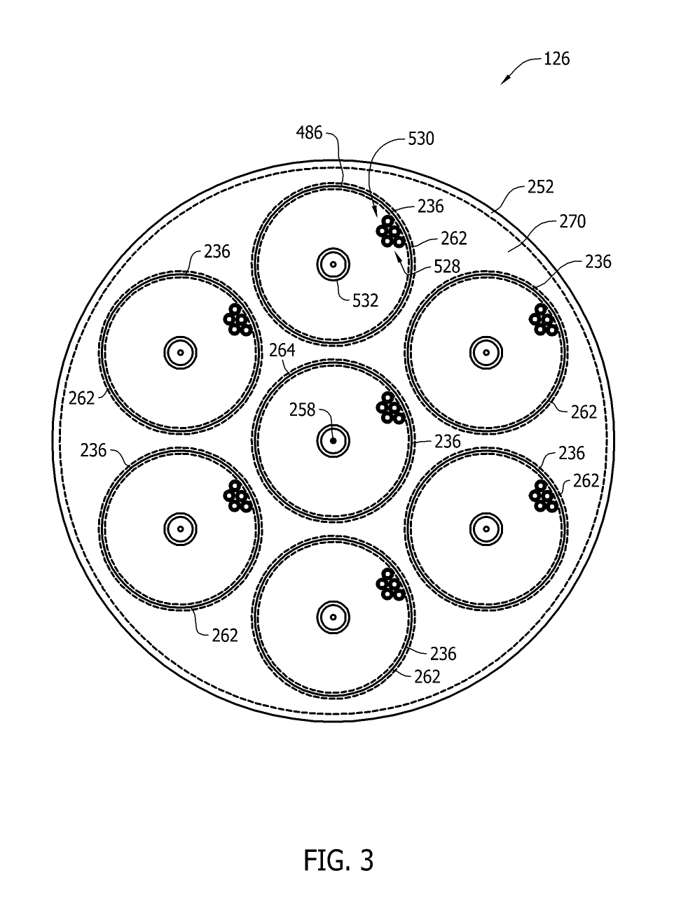

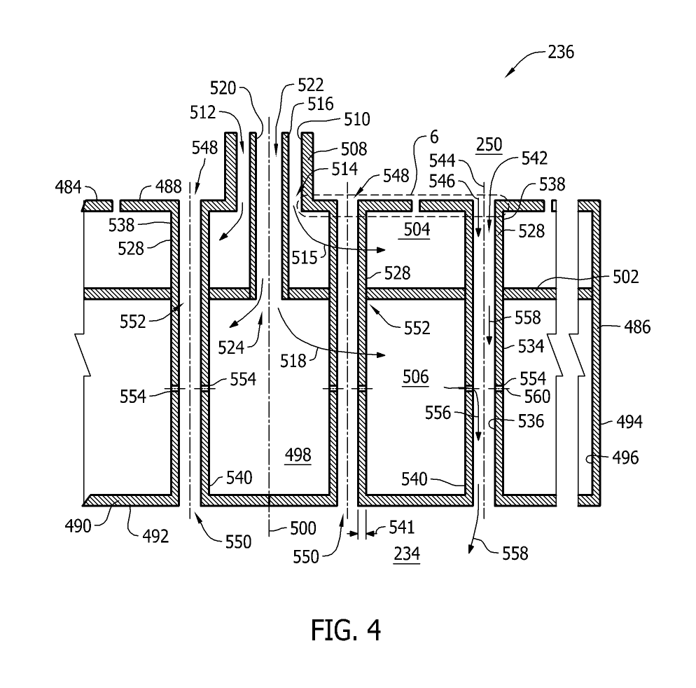

FIG. 2 is a sectional view of an exemplary embodiment of fuel nozzle assembly 126 and taken along area 2 (shown in FIG. 1). FIG. 3 is a sectional view of a portion of fuel nozzle assembly 126 taken along line 3-3 in FIG. 2. FIG. 4 is an enlarged cross-sectional view of a portion of fuel nozzle 236 taken along area 4 in FIG. 2. In the exemplary embodiment, combustor assembly 124 includes a casing 242 that defines a chamber 244 within the casing 242. An end cover 246 is coupled to an outer portion 248 of casing 242 such that an air plenum 250 is defined within chamber 244. Compressor section 114 (shown in FIG. 1) is coupled in flow communication with chamber 244 to channel compressed air downstream from compressor section 114 to air plenum 250.

In the exemplary embodiment, each combustor assembly 124 includes a combustor liner 252 that is positioned within chamber 244 and is coupled in flow communication with turbine section 118 (shown in FIG. 1) through a transition piece (not shown) and with compressor section 114. Combustor liner 252 includes a substantially cylindrically-shaped inner surface 254 that extends between an aft portion (not shown) and a forward portion 256. Inner surface 254 defines annular combustion chamber 234 that extends axially along a centerline axis 258, and extends between the aft portion and forward portion 256. Combustor liner 252 is coupled to fuel nozzle assembly 126 such that fuel nozzle assembly 126 channels fuel and air into combustion chamber 234. Combustion chamber 234 defines a combustion gas flow path 260 that extends from fuel nozzle assembly 126 to turbine section 118. In the exemplary embodiment, fuel nozzle assembly 126 receives a flow of air from air plenum 250, receives a flow of fuel from fuel supply system 138, and channels a mixture of fuel/air into combustion chamber 234 for generating combustion gases.

Fuel nozzle assembly 126 includes a plurality of fuel nozzles 236 that are each coupled to combustor liner 252, and at least partially positioned within air plenum 250. In the exemplary embodiment, fuel nozzle assembly 126 includes a plurality of outer nozzles 262 that are circumferentially oriented about a center nozzle 264. Center nozzle 264 is oriented along centerline axis 258.

In the exemplary embodiment, an end plate 270 is coupled to forward portion 256 of combustor liner 252 such that end plate 270 at least partially defines combustion chamber 234. End plate 270 includes a plurality of openings 272 that extend through end plate 270, and are each sized and shaped to receive a fuel nozzle 236 therethrough. Each fuel nozzle 236 is positioned within a corresponding opening 272 such that fuel nozzle 236 is coupled in flow communication with combustion chamber 234. Alternatively, fuel nozzles 236 may be coupled to combustor liner 252 such that no end plate is needed.

In the exemplary embodiment, each fuel nozzle 236 includes a housing 484 (shown in FIG. 4). Housing 484 includes a sidewall 486 (shown in FIG. 3) that extends between a forward endwall 488 and an opposite aft endwall 490. Aft endwall 490 is oriented between forward endwall 488 and combustion chamber 234, and includes an outer surface 492 that at least partially defines combustion chamber 234. Sidewall 486 includes a radially outer surface 494 and a radially inner surface 496. Radially inner surface 496 defines a substantially cylindrical cavity 498 that extends along a longitudinal axis 500 and between forward endwall 488 and aft endwall 490.

An interior wall 502 is positioned within cavity 498 and extends inwardly from inner surface 496 such that a cooling fluid plenum 504 is defined between interior wall 502 and forward endwall 488, and such that a fuel plenum 506 is defined between interior wall 502 and aft endwall 490. In the exemplary embodiment, interior wall 502 is oriented substantially perpendicularly with respect to sidewall inner surface 496 such that fuel plenum 506 is oriented downstream of cooling fluid plenum 504 along longitudinal axis 500.

In the exemplary embodiment, a plurality of cooling fluid conduits 508 extends from cooling fluid supply system 140 (shown in FIG. 1) to fuel nozzle assembly 126. Each cooling fluid conduit 508 is coupled in flow communication with corresponding fuel nozzle 236. More specifically, cooling fluid conduit 508 is coupled to cooling fluid plenum 504 for channeling a flow of cooling fluid from cooling fluid supply system 140 to cooling fluid plenum 504. Cooling fluid conduit 508 extends between end cover 246 and housing 484 and includes an inner surface 510 that defines a cooling fluid channel 512 within cooling fluid conduit 508 that is coupled to cooling fluid plenum 504. Moreover, cooling fluid conduit 508 is coupled to forward endwall 488 and is oriented with respect to an opening 514 that extends through forward endwall 488 to couple cooling fluid channel 512 to cooling fluid plenum 504. Each cooling fluid channel 512 is coupled to cooling fluid plenum 504 for channeling a flow of cooling fluid 515 from cooling fluid supply system 140 to cooling fluid plenum 504.

A plurality of fuel conduits 516 extend between fuel supply system 138 (shown in FIG. 1) and fuel nozzle assembly 126 for channeling a flow of fuel to fuel nozzle assembly 126. In the exemplary embodiment, each fuel conduit 516 is coupled to a corresponding fuel nozzle 236 for channeling a flow of fuel 518 to fuel plenum 506. Each fuel conduit 516 includes an inner surface 520 that defines a fuel channel 522 that is within fuel conduit 516 and coupled in flow communication with fuel plenum 506.

Fuel conduit 516 is disposed within, and is substantially circumscribed by, cooling fluid conduit 508 and extends through cooling fluid plenum 504 to interior wall 502. Fuel conduit 516 is oriented with respect to an opening 524 that extends through interior wall 502 to couple fuel channel 522 in flow communication with fuel plenum 506.

In the exemplary embodiment, fuel nozzle 236 includes a plurality of mixing tubes 528 that are each coupled to housing 484. Each mixing tube 528 extends through housing 484 to couple air plenum 250 to combustion chamber 234. Mixing tubes 528 are oriented in a plurality of rows 530 (shown in FIG. 3) that extend outwardly from a center portion 532 (shown in FIG. 3) of fuel nozzle assembly 126 towards housing sidewall 486. Each row 530 includes a plurality of mixing tubes 528 that are oriented circumferentially about nozzle center portion 532. Each mixing tube 528 includes an outer surface 534 and a substantially cylindrical inner surface 536, and extends between an inlet portion 538 and an outlet portion 540. Mixing tube 528 includes a width 541 measured between inner surface 536 and outer surface 534. Inner surface 536 defines a flow channel 542 that extends along a centerline axis 544 between inlet portion 538 and outlet portion 540. Inlet portion 538 is sized and shaped to channel a flow of air, represented by arrow 546, from air plenum 250 into flow channel 542 to facilitate mixing fuel and air within flow channel 542.

Forward endwall 488 includes a plurality of inlet openings 548 that extend through forward endwall 488. In addition, aft endwall 490 includes a plurality of outlet openings 550 that extend though aft endwall 490. Each mixing tube inlet portion 538 is oriented adjacent to forward endwall 488 and extends through a corresponding inlet opening 548. Moreover, outlet portion 540 is oriented adjacent to aft endwall 490 and extends through a corresponding outlet opening 550. In addition, each mixing tube 528 extends through a plurality of openings 552 that extend through interior wall 502. In the exemplary embodiment, each mixing tube 528 is oriented substantially parallel with respect to longitudinal axis 500. Alternatively, at least one mixing tube 528 may be oriented obliquely with respect to longitudinal axis 500.

In the exemplary embodiment, one or more mixing tubes 528 include at least one fuel aperture 554 that extends through mixing tube inner surface 536 to couple fuel plenum 506 to flow channel 542. Fuel aperture 554 is configured to channel flow of fuel 518 from fuel plenum 506 to flow channel 542 to facilitate mixing fuel 518 with air 546 to form a fuel-air mixture, represented by arrow 558, that is channeled to combustion chamber 234. In the exemplary embodiment, fuel aperture 554 extends along a centerline axis 560 that is oriented substantially perpendicular to flow channel axis 544. In another embodiment, fuel aperture 554 is oriented obliquely with respect to flow channel axis 544. Alternatively, fuel aperture 554 may be oriented at any angle with respect to flow channel axis 544 that enables fuel nozzle 236 to function as described herein.

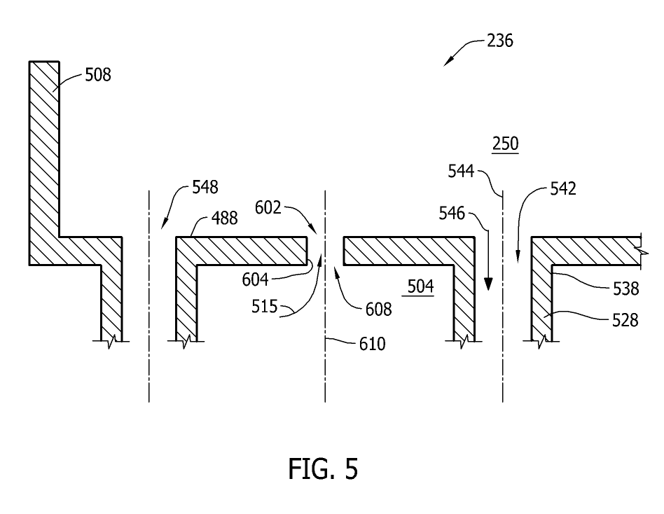

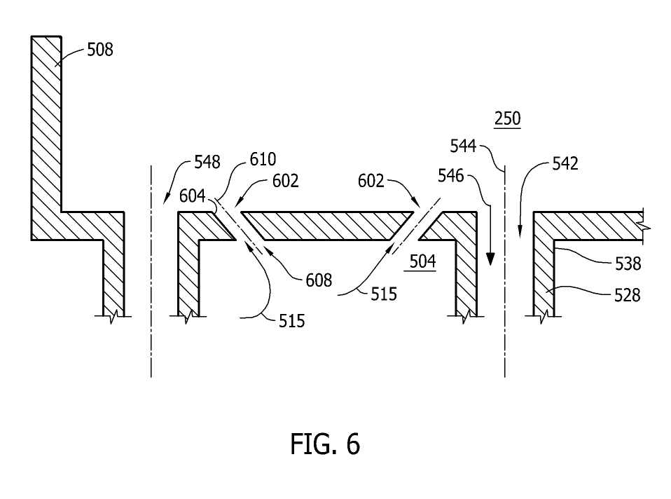

FIG. 5 is an enlarged schematic view of a portion of an exemplary fuel nozzle 236 shown in FIG. 4 and taken along area 6. FIG. 6 is an enlarged schematic view of a portion of an alternative fuel nozzle. In the exemplary embodiment, one or more cooling fluid apertures 602 extend through forward endwall 488 for coupling cooling fluid plenum 504 in flow communication with air plenum 250. Cooling fluid aperture 602 is configured to channel cooling fluid 515 from cooling fluid plenum 504 to air plenum 250. Fuel nozzle 236 may have any number and/or arrangement of cooling fluid apertures 602 to enable fuel nozzle assembly 126 to function as described herein.

In the exemplary embodiment, cooling fluid aperture 602 has a radially inner surface 604 that defines a flow channel 608 that extends along a centerline axis 610. Cooling fluid aperture 602, and therefore centerline axis 610, is substantially parallel to centerline axis 544. Alternatively, at least one cooling fluid aperture 602, and therefore centerline axis 610, may be oriented obliquely with respect to centerline axis 544. More particularly, the oblique angle may be between about 30 to 60 degrees.

During operation, fuel is channeled from fuel supply system 138 through fuel conduit 516 and supplied to fuel nozzle assembly 126, wherein the fuel is mixed with at least air to form a combustible mixture. More specifically, fuel is channeled from fuel conduit 516 to at least one aperture 554 located on mixing tube 528. Air and other fluids flow through mixing tube 528, as shown by arrow 546, and mix with fuel to form the combustible mixture. The combustible mixture is ignited after discharging from outlet opening 550 of fuel nozzle 236 to combustion chamber 234. High concentrations of H₂ burning in combustion chamber 234 generate a high dynamics tone greater than 1 kHz. The high dynamics tone, in extreme cases, causes damage to combustor section 116 or other parts of turbine engine 100.

To reduce the high dynamics tone and NOₓ, other fluids are channeled to combustion chamber 234 via fuel nozzle 236. More specifically, in the exemplary embodiment, when fuel is supplied to nozzle 236, cooling fluid is channeled through cooling fluid conduit 508 to fuel nozzle 236. More specifically, cooling fluid is channeled from cooling fluid supply system 140 (shown in FIG. 1) through cooling fluid channel 512 to cooling fluid plenum 504. The cooling fluid is channeled through at least one aperture 602 and discharged into air plenum 250. The cooling fluid is mixed with air and/or other fluids present in air plenum 250 before flowing through mixing tube 528, as shown by arrows 546, such that the cooling fluid facilitates the reduction of a temperature, e.g., a local peak, in combustion chamber 234, the reduction of the high dynamics tone and the reduction of NOₓ. By reducing the peak temperature of combustion chamber 234, the overall temperature of combustor assembly 124 (shown in FIG. 1) is reduced.

As compared to known apparatus and systems that are used with turbine engines, the above-described fuel nozzle assembly may be used with turbine engines to facilitate reducing the peak temperature generated within a combustor. More specifically, the fuel nozzle assembly includes a plurality of fuel nozzles. Each of the plurality of fuel nozzles includes a plurality of mixing tubes for channeling air, fuel, and other fluids to the combustion chamber. A cooling fluid is channeled through apertures on the cold-side of at least one fuel nozzle for mixing with air and/or other fluids before being channeled through the plurality of tubes to the combustion chamber. By channeling the cooling fluid to at least one of the fuel nozzles, the peak temperature in the combustion chamber is reduced, NOₓ is reduced, combustion dynamics are reduced, and operability and durability of the combustor are increased.

Exemplary embodiments of a fuel nozzle assembly and method of assembling same are described above in detail. The fuel nozzle assembly and method of assembling same are not limited to the specific embodiments described herein, but rather, components of the fuel nozzle assembly and/or steps of the assemblage of the assembly may be utilized independently and separately from other components and/or steps described herein. For example, any of the openings described herein may be used with any of the fuel nozzles described herein. Additionally, the fuel nozzle assembly may also be used in combination with other machines and methods, and is not limited to practice with only a turbine engine as described herein. Rather, the exemplary embodiment can be implemented and utilized in connection with many other systems.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel nozzle for use with a turbine engine, said fuel nozzle comprising:
a housing coupled to a combustor liner defining a combustion chamber, said housing at least partially positioned within an air plenum, said housing comprising an endwall that at least partially defines the air plenum;
a plurality of mixing tubes extending through said housing for channeling a fuel to the combustion chamber;
a cooling fluid plenum at least partially defined within said housing by said endwall; and
a plurality of apertures defined within said endwall for channeling a cooling fluid from said cooling fluid plenum to the air plenum.

2. A fuel nozzle in accordance with claim 1, wherein each of said plurality of apertures is positioned adjacent to at least one of said plurality of mixing tubes.

3. A fuel nozzle in accordance with claim 1, wherein at least one of said plurality of apertures is positioned at an angle with respect to a centerline of at least one of said plurality of mixing tubes.

4. A fuel nozzle in accordance with claim 1, further comprising a fuel plenum at least partially defined within said housing.

5. A fuel nozzle in accordance with claim 4, wherein at least one of said plurality of mixing tubes comprises at least one fuel aperture for channeling fuel from said fuel plenum to said at least one of said plurality of mixing tubes.

6. A fuel nozzle in accordance with claim 4, wherein said cooling fluid plenum is coupled to a cooling fluid conduit and said fuel plenum is coupled to a fuel conduit.

7. A fuel nozzle in accordance with claim 6, wherein said fuel conduit is substantially circumscribed by said cooling fluid conduit.

8. A fuel nozzle in accordance with claim 1, wherein said cooling fluid comprises at least one of a diluent, an inert gas, and air.

9. A combustor assembly for use with a turbine engine, said combustor assembly comprising:
a casing comprising an air plenum;
a combustor liner positioned within said casing and defining a combustion chamber therein; and
a plurality of fuel nozzles coupled to said combustor liner, each fuel nozzle of said plurality of fuel nozzles comprising:
a housing coupled to said combustor liner, said housing comprising an endwall that at least partially defines the combustion chamber;
a plurality of mixing tubes extending through said housing for channeling a fuel to the combustion chamber;
a cooling fluid plenum at least partially defined within said housing by said endwall; and
a plurality of apertures defined within said endwall for channeling a cooling fluid from said cooling fluid plenum to the air plenum.

10. A combustor assembly in accordance with claim 9, wherein each of said plurality of apertures is positioned adjacent to at least one of said plurality of mixing tubes.

11. A combustor assembly in accordance with claim 9, wherein at least one of said plurality of apertures is positioned at an angle with respect to a centerline of at least one of said plurality of mixing tubes.

12. A combustor assembly in accordance with claim 9, further comprising a fuel plenum at least partially defined within said housing.

13. A combustor assembly in accordance with claim 12, wherein at least one of said plurality of mixing tubes comprises at least one fuel aperture for channeling fuel from said fuel plenum to said at least one of said plurality of mixing tubes.

14. A combustor assembly in accordance with claim 12, wherein said cooling fluid plenum is coupled to a cooling fluid conduit and said fuel plenum is coupled to a fuel conduit.

15. A combustor assembly in accordance with claim 14, wherein said fuel conduit is substantially circumscribed by said cooling fluid conduit.

16. A combustor assembly in accordance with claim 9, wherein said cooling fluid comprises at least one of a diluent, an inert gas, and air.

17. A method of assembling a fuel nozzle for use with a turbine engine, said method comprising:
coupling a housing to a combustor liner defining a combustion chamber, the housing at least partially positioned within an air plenum, the housing comprising an endwall that at least partially defines the air plenum;
coupling a plurality of mixing tubes to the housing for channeling a fuel to the combustion chamber;
forming a cooling fluid plenum at least partially within the housing; and
forming a plurality of apertures in the endwall for channeling a cooling fluid from the cooling fluid plenum to the air plenum.

18. A method in accordance with claim 17, further comprising forming a fuel plenum within the housing.

19. A method in accordance with claim 18, further comprising forming at least one fuel aperture within at least one of the plurality of mixing tubes for channeling fuel from the fuel plenum to the at least one of the plurality of mixing tubes.

20. A method in accordance with claim 17, wherein forming a plurality of apertures comprises forming at least one aperture at an angle with respect to a centerline of at least one of the plurality of mixing tubes.
